(19) United States
(12) Patent Application Publication
(10) Pub. No.: US 2026/0188714 A1
(43) Pub. Date: Jul. 2, 2026

(54) Inspection of surface quality in porous transport layers and methods therefor

(71) Applicant: Alliance for Energy Innovation, LLC, Golden, CO (US)

(72) Inventor: Przemyslaw RUPNOWSKI, Golden, CO (US)

(21) Appl. No.: 19/426,751

(22) Filed: Dec. 19, 2025

Related U.S. Application Data
(60) Provisional application No. 63/739,395, filed on Dec. 27, 2024.

(51) Int. Cl. H01M 8/10; G01N 21/95

(52) U.S. Cl. CPC H01M 8/10; G01N 21/95

(57) ABSTRACT

Described herein are method for improved inspection of porous transport layer (PTL) surfaces for use in electrochemical devices such as fuel cells or electrolyzers. The described methods implement an added reflective layer, curving of the PTL surface, or both to enhance detectability of surface defects. By recognizing and addressing these surface defects, electrochemical cell performance and life may be improved by reducing damage caused to the electrolyte membrane when it is attached to the surface of the PTL.

### CROSS-REFERENCE TO RELATED APPLICATIONS

This application claims priority from U.S. Provisional Patent Application No. 63/739,395, filed on Dec. 27, 2025, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Porous transport layers (PTLs) are parts used in electrochemical devices such as fuel cells and electrolyzers. They serve multiple functions, one of them being support for electrolyte membrane. PLTs are generally made of hard materials such as metal or graphite, whereas a membrane is typically a soft polymer that is susceptible to fracture. Because membrane is often pressed against PTL or other intermediate layers including an electrode, surface of PTL needs to be very smooth and with no hard protrusions that potentially can jeopardize mechanical stability of a membrane. Thus, there is a need to inspect the surface of PTL to make sure that that it is of good quality.

During device fabrication and operation, a soft polymer membrane is pressed against the PTL. The protrusions on PTL surface may become stress points and potentially may lead to premature degradation of the membrane. To avoid this potentially performance limiting effect the PLT surface need to be examined.

### SUMMARY

Described herein are methods for improved inspection of porous transport layer (PTL) surfaces for use in electrochemical devices such as fuel cells or electrolyzers. The described methods implement an added reflective layer, curving of the PTL surface, or both to enhance detectability of surface defects. By recognizing and addressing these surface defects, electrochemical cell performance and life may be improved by reducing damage caused to the electrolyte membrane when it is attached to the surface of the PTL.

If implemented in a fuel cell or electrolyzer fabrication process, the methods would allow to screen PTLs allowing only high-quality products to pass and be used to an electrochemical device. As a result, a higher durability and longer lifetime of the devices can be expected.

In an aspect, provided is a method comprising: i) providing a porous transport layer (PTL) for an electrochemical device; ii) coating a surface of the PTL with a reflective layer; and iii) optically analyzing the reflective layer to detect flaws in the PTL.

In an aspect, provided is a method comprising: i) providing a porous transport layer (PTL) for an electrochemical device; ii) deforming the PTL thereby forming a curved surface of the PTL; and iii) optically analyzing the curved surface of the PTL at an angle with respect to the curved surface to detect flaws in the PTL.

The reflective coating can be any thin material that increases the reflectivity of the surface, including for example, a metallic foil such as aluminum foil. In addition to increasing the reflectivity of any present defects on the surface, the reflective coating may also increase the visible size of the defects by enlarging the detectable size of the defect on the surface area of the reflective device.

The PTL layer may comprise additional layers common in electrochemical devices, including a microporous layer to form a dual layer PTL+MPL structure, including where the MPL structure is the outer structure, i.e. the surface being analyzed. Electrostatic force, pressure differential, or both may be employed to conform the reflective layer to the surface of the PTL.

The described flaws may be void spaces or protrusions on the surface of the PTL/MPL including pimples, dents, waviness, orange peel features and/or warping.

Optical detection techniques can be employed to analyzes the modified surfaces for defects or flaws, including for example, specular reflectometry, phase shifting deflectometry, dark field imaging, 1D scanning or a combination thereof.

The described methods may further include removing the reflective layer or deforming the PTL into its original shape. The flaws can then be removed from the surface of the PTL using known methods such as reshaping, grinding, scraping or adding filler material to provide a smother surface. Then, an electrolyte membrane may be applied to the surface of the PTL using known methods.

For instances when the PTL surface is curved, the optical analysis may be performed at an angle from a radius of the circle formed by the surface extended above the point of the surface being analyzed at that time. For example, the angle from the extended radius may be greater than 10° (slightly offset), 12.5°, 15°, 17.5° or greater than 80°, 85°, 87.5°, 89° (near tangential or fully tangential). The angel from the extended radius may be selected from the range of 5° to 15°, 10° to 20°, 75° to 85°, or optionally 80° to 89°.

In addition, the method of adding the reflective layer and curving the surface can both be employed simultaneously and in conjunction to gain the added detection effects of both described methods.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates an example porous transport layer (PTL) showing exemplary defects on the surface.

FIG. 2 shows the issue of the defects on the surface of the PTL, as the soft membrane is applied from the top, the voids and protrusions cause damage to the membrane.

FIG. 3 illustrates the benefit of adding a reflective layer to the surface of the flawed PTL, the added layer increases reflectivity and increases the visibility (surface area) of the defects making them easier to detect.

FIG. 4 provides an example of a flawed PTL being curved within its elastic deformation range, thereby increasing the detectability of the defects on the surface.

FIG. 5 provides an example of a tangential analysis of the curved PTL, where the curved surface provides more contrast in the horizontal direction and increases the effectiveness of the optical detection technique.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

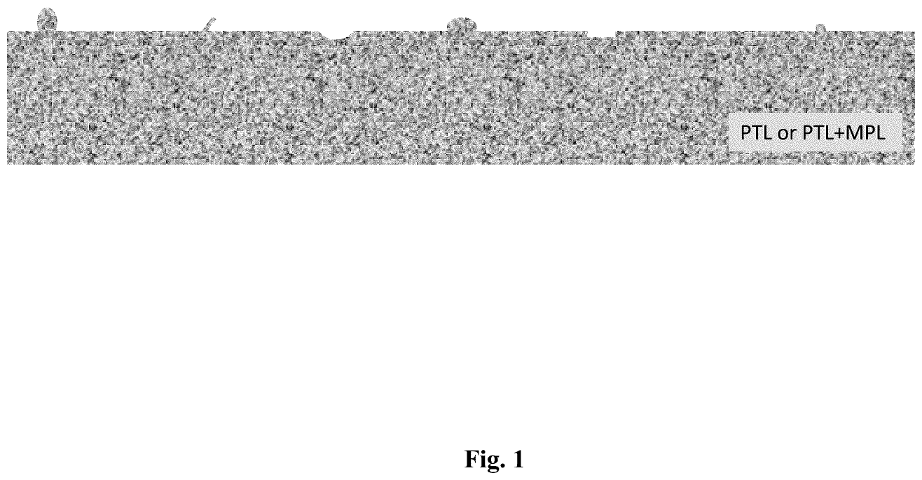

An issue in the performance of electrochemical cells is the degradation of the electrolyte membrane due to the surface defects in the adjacent PTL or the dual layer PTL and microporous layer (PTL+MPL). The PTL is generally made of hard materials such as titanium or carbon fiber/particles. Ideally, the surface of the PTL that is going to be adjacent to the electrolyte membrane should be very smooth. However, there are often very small protrusions and voids on the surface of the PTL as illustrated in FIG. 1.

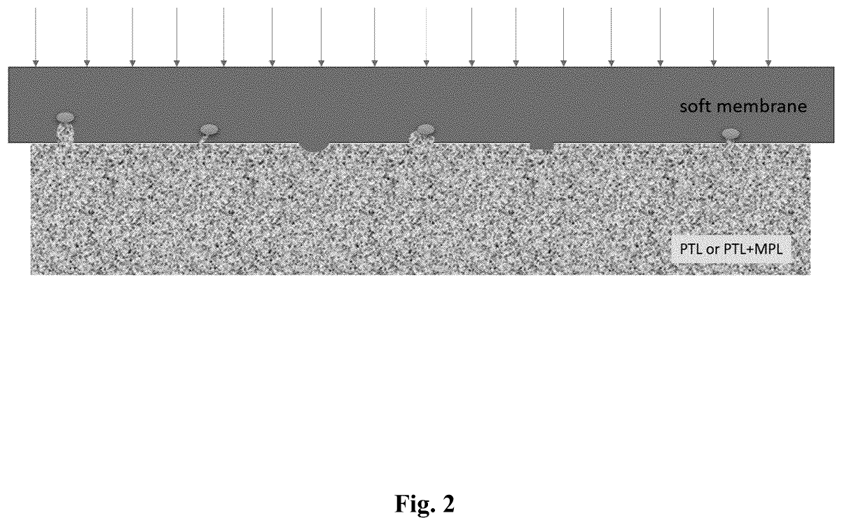

When the electrochemical cell is being assembled, the electrolyte membrane is pressed on to the surface of the PTL as shown in FIG. 2. The electrolyte membrane is often made of a soft polymeric material and the protrusion and voids on the surface of the PTL create stress points in the soft membrane layer which can lead to premature degradation of the membrane or reduced efficiency of the cell. To avoid this effect, it is beneficial to examine the surface of the PTL prior to the addition of the membrane. However, these defects are often very small and can be difficult to detect.

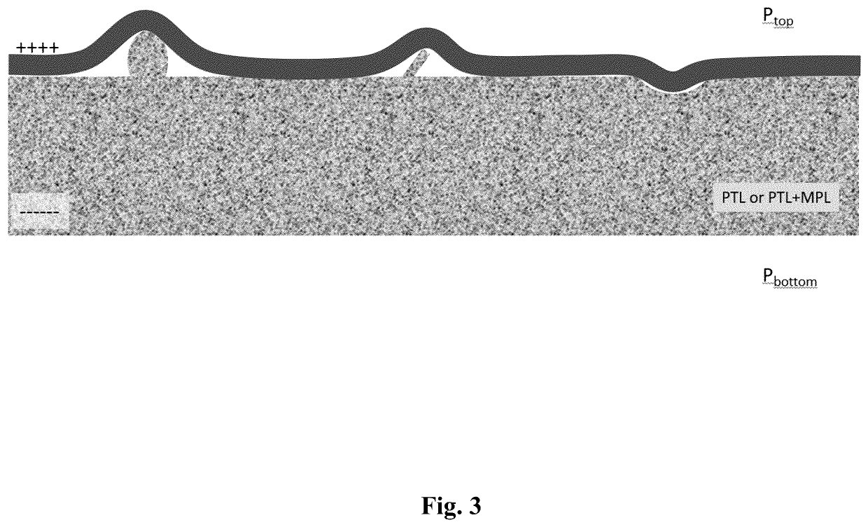

As one example method, as described herein, a reflective layer with constant thickness is applied to the surface of the PTL. Electrostatic force or a pressure differential can be used to ensure that the reflective layer is uniformly conformed to the surface of the PTL, as illustrated in FIG. 3. The benefits of adding this layer increase the efficiency of optical detection techniques by increasing the reflectivity of the surface and increasing the visible size of the defect area, reducing the resolution requirements of the employed optical imaging system. Additionally, increased optical resolution for detection devices is generally exponentially more expensive as resolution is increased, potentially allowing for lower power (and thus lower cost) devices to accurate analyze the PTL surface. Known methods of optical detection can be used, for example, specular reflectometry, phase shifting deflectometry or dark field imaging (1D scanning) can be used to find the defects via the enlarged bumps and indentations on the foil surface.

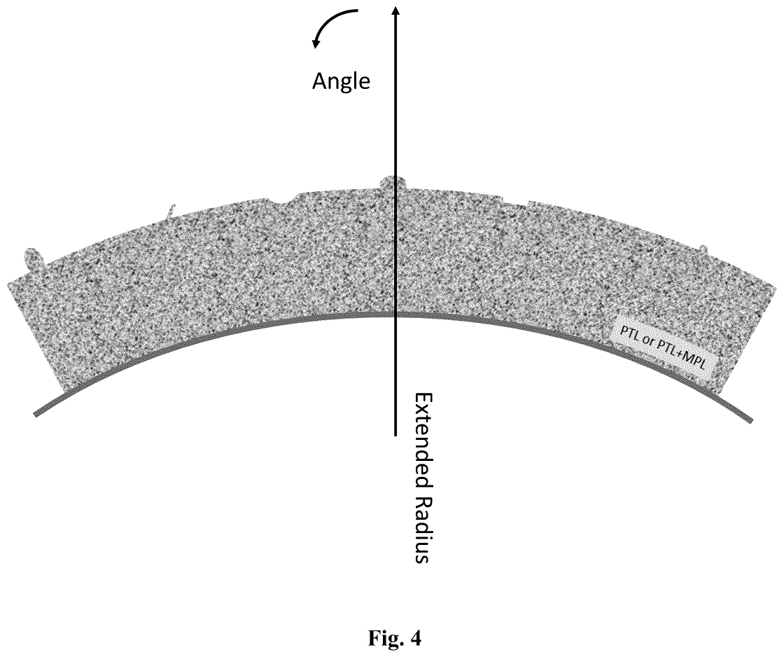

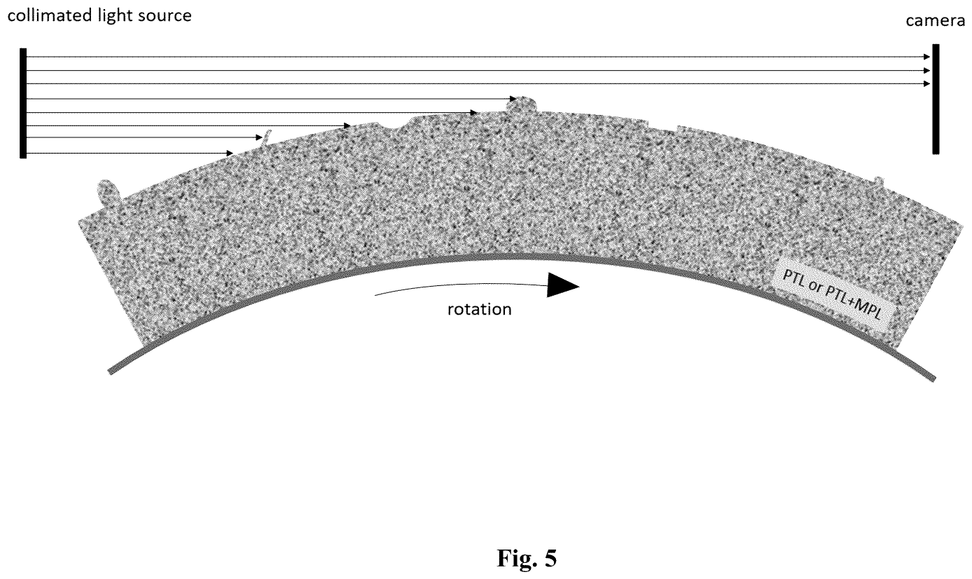

Another method for enhancing the detectability of defects on the surface of the PTL is to curve the PTL slightly within the elastic deformation range as described herein and illustrated in FIG. 4. The PTL can then be slowly rotated and an optical shadow method or angled optical analysis can detect defects with improved accuracy. In the example of the optical shadow method (as shown in FIG. 5), protrusions can be identified by processing the image captured by the camera (here angled tangentially) and the resulting video stream can be analyzed via image processing for all captured rotation angles.

The invention may be further understood from the following non-limiting examples:
Example 1. A method comprising:
providing a porous transport layer (PTL) for an electrochemical device;
coating a surface of the PTL with a reflective layer; and
optically analyzing the reflective layer to detect flaws in the PTL.
Example 2. The method of example 1, wherein the reflective layer is a metallic foil.
Example 3. The method of example 1 or 2, wherein the PTL further comprises a microporous layer as a double layer structure.
Example 4. The method of any of examples 1-3, wherein the step of optically analyzing comprises utilizing specular reflectometry, phase shifting deflectometry, dark field imaging, 1D scanning or a combination thereof.
Example 5. The method of any of examples 1-4, wherein the reflective layer increases the reflectivity of defects, increases the size of the defects or both.
Example 6. The method of any of examples 1-5, wherein the flaws in the PTL comprises void spaces or protrusions.
Example 7. The method of any of examples 1-6, wherein the step of coating the surface of the PTL comprises using electrostatic force, pressure differential or both to conform the reflective layer to the surface of the PTL.
Example 8. The method of any of examples 1-7 further comprising removing the flaws in the PTL.
Example 9. The method of example 8, further comprising removing the reflective layer; and
applying an electrolyte membrane to the surface of the PTL.
Example 10. The method of any of examples 1-9 further comprising physically deforming the PTL thereby forming a curve on the surface of the PTL, wherein the step of optically analyzing is performed at an angle with respect to the curve.

Example 11. A method comprising:
providing a porous transport layer (PTL) for an electrochemical device;
deforming the PTL thereby forming a curved surface of the PTL; and
optically analyzing the curved surface of the PTL at an angle with respect to the curved surface to detect flaws in the PTL.
Example 12. The method of example 11, wherein the PTL further comprises a microporous layer as a double layer structure.
Example 13. The method of examples 11 or 12, wherein the step of optically analyzing comprises utilizing specular reflectometry, phase shifting deflectometry, dark field imaging, 1D scanning or a combination thereof.
Example 14. The method of any of examples 11-13, wherein the step of deforming is performed that the deformation is within the elastic deformation range of the PTL.
Example 15. The method of any of examples 11-14, wherein the angle is greater than 10° from the extended radius of the point of the curve being analyzed.
Example 16. The method of any of examples 11-14, wherein the angel is greater than 80° from the extended radius of the point of the curve being analyzed.
Example 17. The method of any of examples 11-16, wherein the flaws in the PTL comprises void spaces or protrusions.
Example 18. The method of any of examples 1-17 further comprising removing the flaws in the PTL.
Example 19. The method of example 18, further comprising applying an electrolyte membrane to the surface of the PTL.
Example 20. The method of any of examples 11-19, further comprising coating a surface of the PTL with a reflective layer.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
providing a porous transport layer (PTL) for an electrochemical device;
coating a surface of the PTL with a reflective layer; and
optically analyzing the reflective layer to detect flaws in the PTL.

2. The method of claim 1, wherein the reflective layer is a metallic foil.

3. The method of claim 1, wherein the PTL further comprises a microporous layer as a double layer structure.

4. The method of claim 1, wherein the step of optically analyzing comprises utilizing specular reflectometry, phase shifting deflectometry, dark field imaging, 1D scanning or a combination thereof.

5. The method of claim 1, wherein the reflective layer increases the reflectivity of defects, increases the size of the defects or both.

6. The method of claim 1, wherein the flaws in the PTL comprises void spaces or protrusions.

7. The method of claim 1, wherein the step of coating the surface of the PTL comprises using electrostatic force, pressure differential or both to conform the reflective layer to the surface of the PTL.

8. The method of claim 1 further comprising removing the flaws in the PTL.

9. The method of claim 8, further comprising removing the reflective layer; and
applying an electrolyte membrane to the surface of the PTL.

10. The method of claim 1 further comprising physically deforming the PTL thereby forming a curve on the surface of the PTL, wherein the step of optically analyzing is performed at an angle with respect to the curve.

11. A method comprising:
providing a porous transport layer (PTL) for an electrochemical device;
deforming the PTL thereby forming a curved surface of the PTL; and
optically analyzing the curved surface of the PTL at an angle with respect to the curved surface to detect flaws in the PTL.

12. The method of claim 11, wherein the PTL further comprises a microporous layer as a double layer structure.

13. The method of claim 11, wherein the step of optically analyzing comprises utilizing specular reflectometry, phase shifting deflectometry, dark field imaging, 1D scanning or a combination thereof.

14. The method of claim 11, wherein the step of deforming is performed that the deformation is within the elastic deformation range of the PTL.

15. The method of claim 11, wherein the angle is greater than 10° from the extended radius of the point of the curve being analyzed.

16. The method of claim 11 wherein the angel is greater than 80° from the extended radius of the point of the curve being analyzed.

17. The method of claim 11, wherein the flaws in the PTL comprises void spaces or protrusions.

18. The method of claim 11 further comprising removing the flaws in the PTL.

19. The method of claim 18, further comprising applying an electrolyte membrane to the surface of the PTL.

20. The method of claim 11, further comprising coating a surface of the PTL with a reflective layer.
